(19) United States
(12) Patent Application Publication
(10) Pub. No.: US 2026/0235268 A1
(43) Pub. Date: Aug. 13, 2026

(54) RELIABLE HIGH STRENGTH, WATERPROOF LIGHT STRING

(71) Applicant: LEDup Manufacturing Group Limited, City of Industry, CA (US)

(72) Inventors: Jing Jing Yu, City of Industry, CA (US); Franco Li, City of Industry, CA (US)

(73) Assignee: LEDup Manufacturing Group Limited, City of Industry, CA (US)

(21) Appl. No.: 19/538,201

(22) Filed: Feb. 12, 2026

Related U.S. Application Data
(60) Provisional application No. 63/758,045, filed on Feb. 13, 2025.

(51) Int. Cl. F21S 4/10; F21V 19/00; F21Y 115/10

(52) U.S. Cl. CPC F21S 4/10; F21V 19/003; F21Y 2115/10

(57) ABSTRACT

Disclosed is a reliable, high strength, waterproof light string that has lamp housings secured along the length of a light string which maintains the integrity of the insulated power wire, which is not cut, to make connections to each of the light assemblies. Conductive connections are made between a circuit board and conductive screws that extend through the circuit board and penetrate an insulation layer of the power wire and extend into a stranded conductive lead. Assembly of the light string eliminates a number of complex steps and provides a better, and stronger light string that is not prone to separation.

### BACKGROUND OF THE INVENTION

LED light strings provide light for various purposes such as decorative lighting, utility lighting, and general lighting. Light strings that are used for exterior lighting must be reliable, strong and resist environmental conditions and abuse. It is therefore advantageous to provide a light string that can be used for exterior lighting that is waterproof, reliable and has high strength.

### SUMMARY OF THE INVENTION

An embodiment of the present invention may therefore comprise light string that resists being pulled apart comprising: an insulated power wire having stranded conductive leads and insulation covering said conductive lead; a lamp holder surrounding said insulated power wire, said lamp holder having a cavity that exposes said insulated wire, said lamp holder fixed to said insulated power wire; a circuit board having light emitting diodes, said circuit board adapted to fit on said circuit board holder in a fixed position relative to said lamp holder so that openings in said circuit board align with conductive leads of said insulated power wire; a circuit board holder located in said cavity of said housing; printed circuit board leads on said printed circuit board proximate to or disposed in or around said openings in said circuit board; conductive screws that extend through said openings in said circuit board and are secured in said insulation covering and contact said stranded conductive leads without causing damage to said stranded conductive leads which creates a conductive connection between said printed circuit board leads and said conductive leads of said insulated power wire without cutting said insulated wire replacing said with thee.

An embodiment of the invention may further comprise a method of making a light string that is strong and resists being pulled apart comprising; forming a lamp holder around an insulated wire so that said insulated wire passes through a cavity in said lamp holder; providing a circuit board having light emitting diodes, a power driving chip that converts power from power supplied to said light string to a voltage that can be used by said light emitting diodes to generate light; forming a circuit board holder in said cavity of said lamp holder to hold said circuit board in a predetermined position in said lamp holder; placing a lens in said cavity over said light emitting diodes to direct light from said light emitting diodes to a diffuser; placing said diffuser in said lamp holder over said lens so that light is directed from said light emitting diodes to an inside surface of said diffuser; placing conductive screws in holes in said circuit board so that said screws are aligned with conductive leads of said insulated wire; screwing said screws through said holes in said circuit board and through insulation on said insulated wire and into said conductive leads at said insulated wire so that power is supplied to power leads on said circuit board without cutting said insulated wire and not weakening said insulated wire replacing said with thee.

### BRIEF DESCRIPTION OF THE DRAWINGS

FIGS. 1 and 2 illustrate a prior art light string connecter system.

FIG. 3 illustrates an embodiment of a lamp assembly of a light string constructed in accordance with the present invention.

FIG. 4 is an exploded diagram of the embodiment of FIG. 3.

FIG. 5 is an isometric view of the lamp housing of the embodiment of FIG. 3.

FIG. 6 is a side view illustrating the structure of the light emitting diodes of the lamp assembly and circuit board.

FIG. 7 is an isometric view of the circuit board and wire showing the screw connectors.

FIG. 8 is a cutaway view illustrating the conductive screws penetrating the stranded conductive lead.

FIG. 9 is a side view of the light string utilizing lamp assemblies illustrated in the embodiment of FIG. 3.

### DETAILED DESCRIPTION OF THE EMBODIMENTS

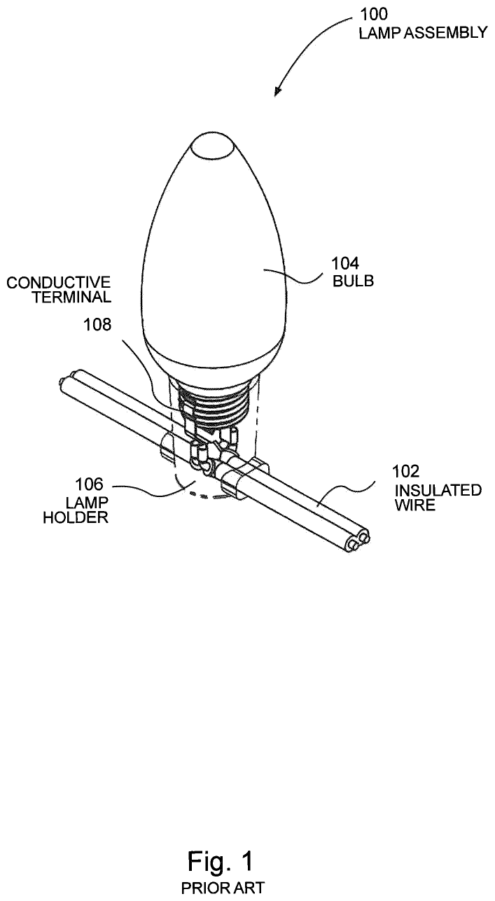

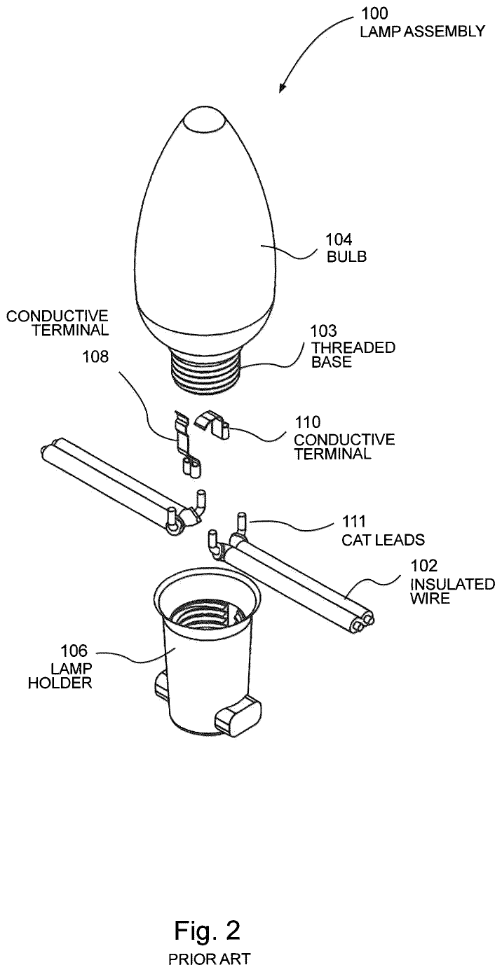

FIGS. 1 and 2 illustrate a typical prior art light assembly utilized in prior art light strings. As illustrated in FIGS. 1 and 2, insulated power wire 100 provides power to the lamp assembly 100. As illustrated in FIGS. 1 and 2, the insulated power wire 102 is cut in order to mount a conductive terminals 108, 110 on the cut ends of the conductive leads of power wire 102. The conductor terminals 108, 110 are then connected to power terminals on bulb 104. This requires the insulated power wire 102 to be cut, the internal cut leads 111 of insulated power wire to be exposed by removing insulation and conductive terminals 108, 110 to be connected to the exposed conductive leads of the insulated power wire 102 and soldered together. Not only does this require a significant number of steps, the cutting of the wire weakens the overall strength of the light string. Light strings are often pulled or yanked while in use for various reasons such as removing the light string from an elevated position, pulling the light string through low access areas, etc. When yanked or pulled hard enough, the light string can come apart and be separated at these locations where the wire is cut. The strength of the insulated wire 102 is significantly reduced as the result of the wire being cut. As such, these prior art systems cannot rely upon the strength of the insulated power wire 102.

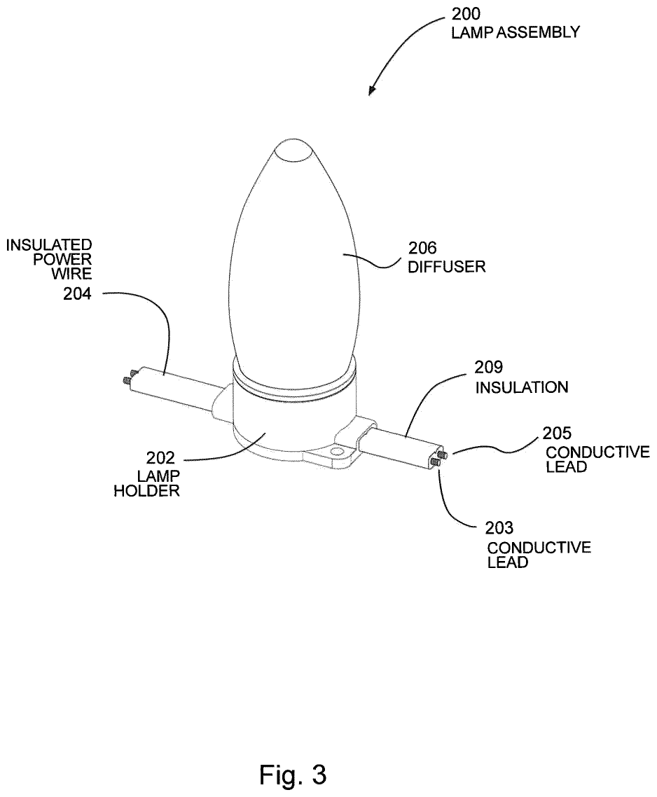

FIG. 3 is an isometric view of a light assembly 200 which comprises an embodiment of the present invention. As illustrated in FIG. 3, the lamp assembly 200 includes a lamp housing 202 and insulated power wire 204 that passes through the lamp housing 202. Light diffuser 206 is coupled the lamp housing 202 using a waterproof seal.

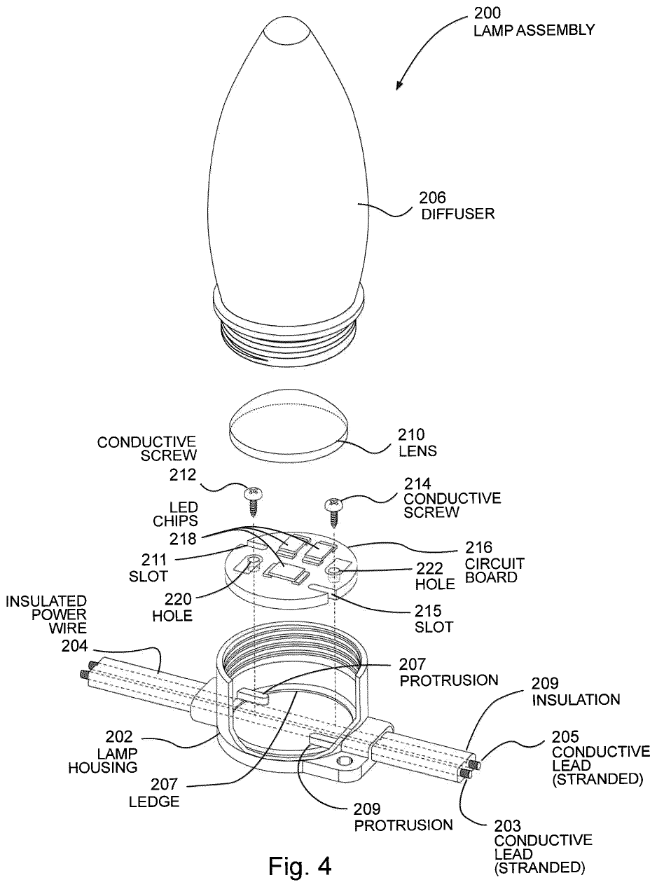

FIG. 4 illustrates the lamp assembly 200 in an exploded view. As illustrated in FIG. 4, the lamp housing 202 surrounds, and is secured to, the insulated wire 204. The lamp housing 202 can be injection molded around the insulated wire 204 or separately injected molded with the insulated wire strung through the bottom portion of the lamp housing 202 and secured firmly to the lamp housing 202. Injection molding the lamp housing 202 around the insulated wire 204 creates a solid non-movable structure in which the lamp housing 202 is solidly connected to the insulated wire 204. In another embodiment, the lamp housing 202 can be made in two or more parts and assembled around the insulated wire 204 so that the lamp housing 202 is affixed to the insulated wire 204 and the insulated wire 204 passes through the cavity of the lamp housing 202, illustrated in FIG. 4. The assembly of at least two parts can squeeze the insulated wire 204 to fix the lamp housing 202 in a position on the insulated wire 204, or alternatively, the insulated wire 204 can be bonded to the lamp housing 202 using any desired means such as by adhesive, plastic welding or other known methods.

As also shown in FIG. 4, a circuit board 216 has LED chips 218 mounted directly to the circuit board 216. This is referred to as chip on board (COB) LEDs. The circuit board 216 fits within the interior of the lamp housing 202. Circuit 216 has slots 211, 215 that engage protrusions 207, 209, respectively, on the interior of the lamp housing 202. In this manner, the rotational orientation of the round circuit board 216 is fixed and holes 220, 222 are aligned with each of the leads of insulated wire 204. Of course, only one protrusion and one slot can be used to rotationally orient the circuit board 216 with the lamp housing 202. In that regard, any type of keying device can be used to rotationally orient the circuit board 216. Conductive screws 212, 214 extend through the holes 220,222, respectively, in the round circuit board 216 and engage each of the leads of the insulated wire 204 to create a conductive path between each of the leads 203, 205, respectively, of the insulated wire 204 and conductive leads on circuit board 216. In this manner, power is supplied to the circuit board 216 to operate the LED chips 218. In some embodiments, the circuit board 216 is covered in epoxy and secured to the interior portion of the lamp housing 202. This provides additional waterproofing of the electrical components of the lamp assembly. Of course, the epoxy is transparent so that light can travel from the LED chips 218 to diffuser 206. Lens 210 is then placed over the circuit board 216 which causes the light emitted from the LED chips 218 to be directed on to the inside surface of the diffuser 206. Diffuser 206 can then be screwed on to the threaded or ribbed interior of the lamp housing 202 together with a gasket or the diffuser 206 or can be bonded using glue, or plastic welded into place. In this manner, a waterproof secure assembly is created that can be used in outdoor environments and has the strength of the insulated wire 204 when the light string is pulled. Of course, any desired form of mounting of the circuit board 216 in the lamp housing 202 can be used. A ledge 205 or stops around the interior circumference of lamp housing 202, having any type of key that interfaces with the circuit board 216, can be used to properly locate the circuit board 216 both vertically, horizontally and rotationally. Conductive leads on the printed circuit board are proximate to, surround, or continue through holes 220, 222 so that the conductive screws 212, 214 make contact with the conductive leads around or in the holes 220, 222. Since the conductive screws 212, 214 penetrate the insulation 209 of the insulated wire 204, and contact the stranded conductive leads 203, 205, a conductive path is made between the conductive leads on the circuit board 216 proximate to or extending through holes 220, 222, and the conductive leads 203, 205 of insulated power wire 204. Further, the conductive screws 212, 214 are small enough and thin enough to penetrate the stranded conductive leads 203, 205 without damaging or breaking the stranded conductive leads 203, 205. In that regard, the insulated wire 204 has conductive leads 203, 205 which are stranded wire (not solid) so that the screws 212, 214 can penetrate the bundle of stranded wires of each of the conductive leads 203, 205 without compromising the strength of the conductive leads 203, 205.

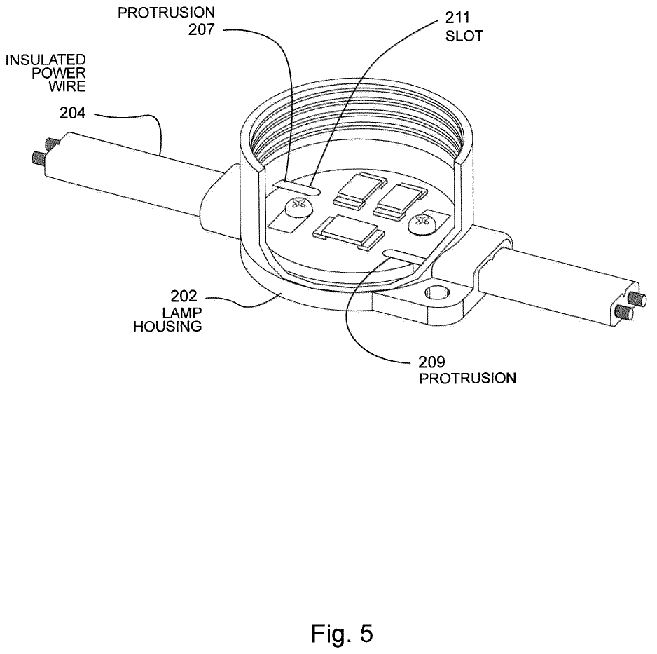

FIG. 5 is an isometric cut away view showing the lamp housing 202 and the insulated wire 204 extending through the lamp housing 202 without being cut. Insulated wire 204 has the strength of the insulation and metal core of the stranded conductive leads 203, 205 of the wire 204. A ledge 205 or stops (FIG. 4) is provided within the lamp housing 202 to support the circuit board 216 (FIG. 4) and at least one notch or protrusion is provided in the circuit board that engages the notch or protrusion to rotationally orient the circuit board, as shown in FIG. 5.

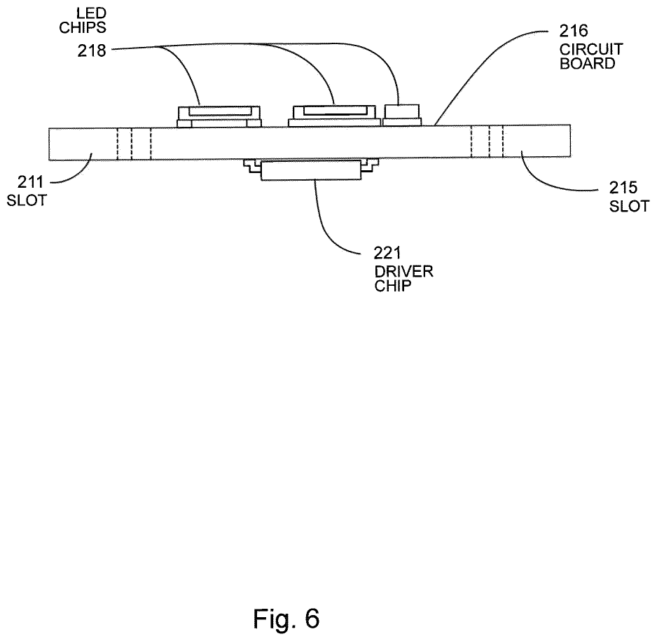

FIG. 6 is a side view of the printed circuit board 216. As shown in FIG. 6, LED chips 218 are connected to the top surface of the circuit board 216 while driver chip 220 is attached to the bottom surface of the circuit board 216. Driver chip 220 converts the power received from the insulated wire 204 to a DC or AC voltage that is applied to, and is compatible with, the LED chips 218. Slots 211 and 215 in circuit board 216 are also shown.

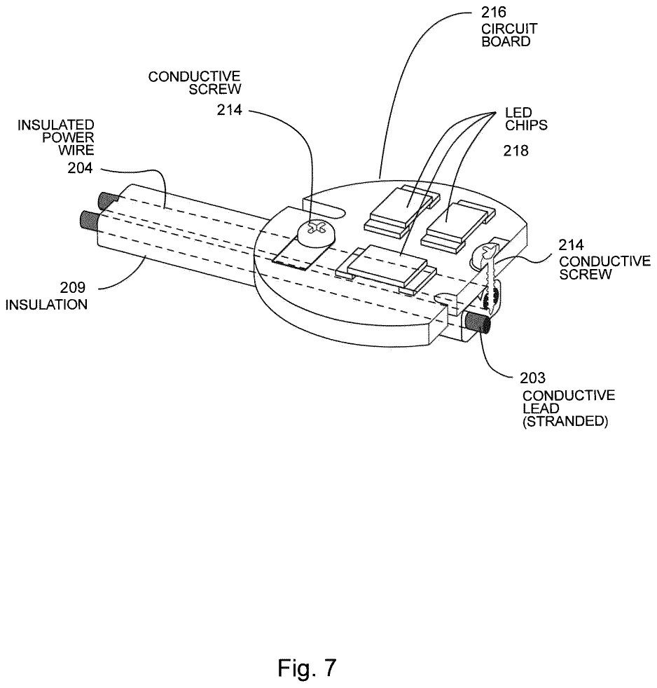

FIG. 7 is an isometric view of the circuit board 216 with the conductive screws 212, 214 extending through the circuit board 216, into the insulated wire and contacting the stranded conductive leads 203, 205 of the insulated power wire 204. Screws 214 have a sufficiently thin shaft to penetrate the stranded conductive leads 203, 205 without causing damage to stranded conductive leads 203, 205. Each of the screws 212, 214 rests on a conductive portion of the circuit board 216 so that a conductive path is created between each of the conductive leads of the insulated wire 204 and conductors on the printed circuit board 216.

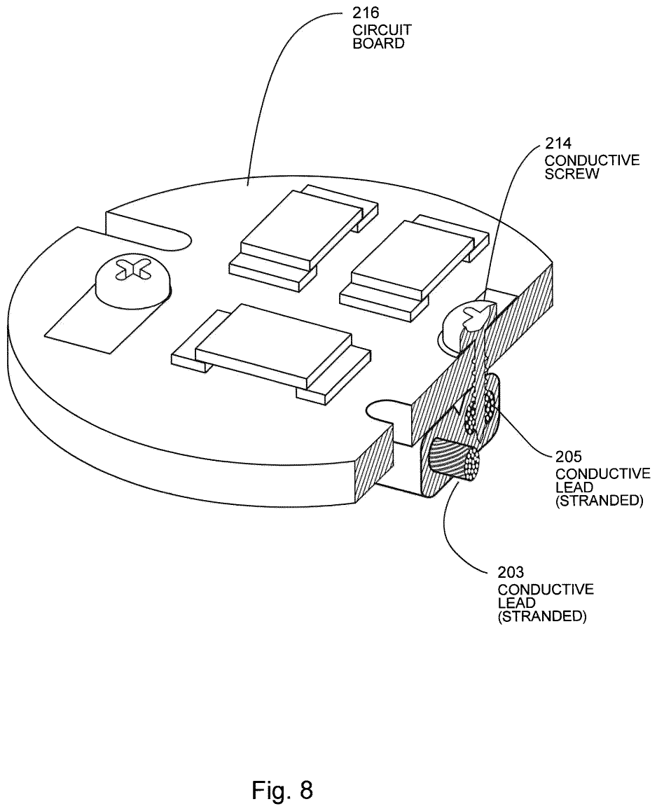

FIG. 8 is an isometric cutaway view illustrating the circuit board 216 and the conductive leads 203, 205 which are penetrated by the conductive screw 214. Again, the shaft of the conductive screw 214 is sufficiently thin so that the screws can penetrate the stranded conductive lead 205 to create a conductive path and not damage the stranded conductive lead 205.

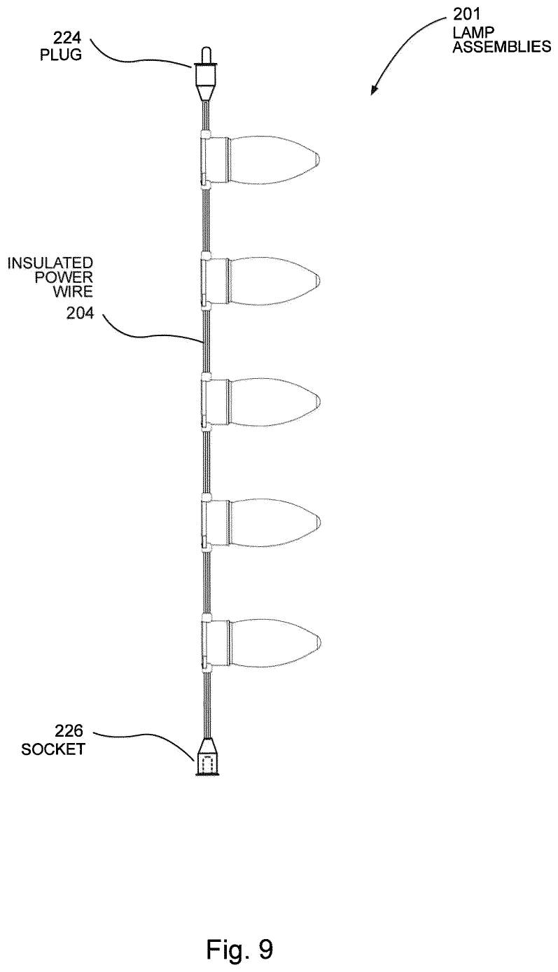

FIG. 9 is a side view of a light string 201 comprising a series of lamp assemblies 200 that are connected together by insulated wire 204. The insulated wire 204 is connected to a plug 224 on one end and a socket 226 on the other end. AC power from a wall socket can be transmitted by the insulated wire 204 to each of the light assemblies 200 so that the driver chip can convert the AC wall current into direct current at a voltage that is compatible with the LED chips 218. Alternatively, driver chip 221 may simply convert the voltage of the wall signal to a voltage that can be used by the LED chips 218.

Accordingly, the present invention utilizes a unique design for a light string that maintains the strength of the insulated wire connecting the lamp assemblies so that the light string does not separate and come apart when pulled. The wire is not cut, as it is in prior art light strings, and extends through a lamp housing 202 without being cut. Conductive connections are made between a circuit board 216 and each of the leads of the insulated wire 204 using conductive screws that secure the printed circuit board 216 in place inside the lamp housing 202. The structure provides a secure and high strength light string that is not prone to separation when pulled or yanked. In addition, the lamp assembly 200 is easy to assemble and eliminates a number of different steps required in the prior art to make conductive connections between the LED lamps and insulated conductive wires.

What is claimed is:

1. A light string that resists being pulled apart comprising:
an insulated power wire having stranded conductive leads and insulation covering said conductive lead;
a lamp holder surrounding said insulated power wire, said lamp holder having a cavity that exposes said insulated wire, said lamp holder fixed to said insulated power wire;
a circuit board having light emitting diodes, said circuit board adapted to fit on said circuit board holder in a fixed position relative to said lamp holder so that openings in said circuit board align with conductive leads of said insulated power wire;
a circuit board holder located in said cavity of said housing;
printed circuit board leads on said printed circuit board proximate to or disposed in or around said openings in said circuit board;
conductive screws that extend through said openings in said circuit board and are secured in said insulation covering and contact said stranded conductive leads without causing damage to said stranded conductive leads which creates a conductive connection between said printed circuit board leads and said conductive leads of said insulated power wire without cutting said insulated wire.

2. The light string of claim 1 wherein said circuit board holder comprises;
at least one protrusion from a ledger of said circuit board holder;
at least one slot formed in said circuit board that engages said at least one protrusion.

3. The light string of claim 1 wherein said light emitting diodes are chip-on-board light emitting diodes that are mounted on said circuit board.

4. The light string of claim 1 wherein said lamp holder is injection molded around said insulated power wire.

5. The light string of claim 1 wherein said lamp holder is formed in at least two parts, and is assembled around, and secured to, said insulated power wire.

6. The light string of claim 5 wherein said lamp holder is secured to said insulated power wire using plastic welding.

7. A method of making a light string that is strong and resists being pulled apart comprising;
forming a lamp holder around an insulated wire so that said insulated wire passes through a cavity in said lamp holder;
providing a circuit board having light emitting diodes, a power driving chip that converts power from power supplied to said light string to a voltage that can be used by said light emitting diodes to generate light;
forming a circuit board holder in said cavity of said lamp holder to hold said circuit board in a predetermined position in said lamp holder;
placing said diffuser in said lamp holder over said lens so that light is directed from said light emitting diodes to an inside surface of said diffuser;
placing conductive screws in holes in said circuit board so that said screws are aligned with conductive leads of said insulated wire;
screwing said screws through said holes in said circuit board and through insulation on said insulated wire and into said conductive leads at said insulated wire so that power is supplied to power leads on said circuit board without cutting said insulated wire and not weakening said insulated wire.

8. The method of claim 7 wherein said circuit board holder includes protrusions that interface with slots on said circuit board to rotationally locate said circuit board.

9. The method of claim 7 wherein said light emitting diodes comprise chip-on-board light emitting diodes mounted on said circuit board.

10. The method of claim 7 wherein said process of forming said lamp holder around said insulated wire comprises injection molding said lamp holder around said insulated wire.

11. The method of claim 7 wherein said process of forming said lamp holder around said insulated wire comprises forming said lamp holder in at least two parts and bonding said lamp holder around said insulated wire.

12. The method of claim 7 further comprising placing a lens in said cavity over said light emitting diodes to direct light from said light emitting diodes to said diffuser.
